(19) United States
(12) Patent Application Publication
(10) Pub. No.: US 2025/0181610 A1
(43) Pub. Date: Jun. 5, 2025

(54) GEOSPATIAL INFORMATION SYSTEM

(71) Applicant: SkymatiX, Inc., Tokyo (JP)

(72) Inventors: Zentaro WATANABE, Tokyo (JP); Tetsuya OIKAWA, Tokyo (JP); Yasutaka KURAMOTO, Tokyo (JP)

(21) Appl. No.: 18/725,630

(22) PCT Filed: Dec. 22, 2022
(86) PCT No.: PCT/JP2022/047495

§ 371 Date: Jun. 28, 2024

(30) Foreign Application Priority Data
Jan. 5, 2022 (JP) 2022-000498

(51) Int. Cl. G06F 16/29; G06F 3/04817; G06F 3/04842; G06F 3/04847; G06F 3/0485; G06F 16/9537; G06F 16/9538; G06T 11/00; G06T 17/05

(52) U.S. Cl. CPC G06F 16/29; G06F 3/04847; G06F 3/0485; G06F 16/9537; G06F 16/9538; G06T 11/00; G06T 17/05; G06F 3/04817; G06F 3/04842; G06T 2200/24

(57) ABSTRACT

Provided is a geospatial information system which can be applied to a wide range of different usages or user needs. The geospatial information system 1 includes: a database 11; a content registration unit 13 which registers, in the database, geospatial content uploaded from a user; and a content display unit 19 which provides, to a user terminal, a geospatial information screen on which the registered geospatial content is displayed. The registrable geospatial content includes a mono image, an orthoimage, a moving image, three-dimensional model data, analysis result data thereof, and the like. In the geospatial information screen, an overlap display and a divisional display may be selected. For the overlap display, content display arrangement is in the order of a map, an orthoimage, and other content icons from the rear surface toward the front surface.

### TECHNICAL FIELD

This invention relates to a geospatial information system which manages and visually displays information on geospatial spaces, in which geospatial objects such as land, natural objects, artificial objects, and the like are present, in association with geospatial positions of the geospatial spaces.

### BACKGROUND ART

For example, PTL1 describes a disaster-prevention/disaster-recovery support system using a geospatial information system. Usages of this disaster-prevention/disaster-recovery support system are support for formation of measures for preventing damage before occurrence of a disaster, support for recovery works after occurrence of a disaster and the like.

In this system, on the basis of flood-depth information that has been input, a flood-depth layer in which associates the flood-depth information is associated with topographical map information is generated, different colors are applied to the flood-depth layers in accordance with the flood depths, and the flood-depth layers are overlap-displayed on the topographical map information.

### CITATION LIST

### Patent Literature

### [PTL 1]

Japanese Patent Application Publication No. 2007-220030

### SUMMARY OF INVENTION

### Technical Problem

The usages in which the geospatial information system can be exploited are widely varied in addition to the disaster measures as described above. Moreover, even in the same usage, needs for the map information system might be different depending on users. Therefore, types of geospatial information which is to be managed by the geospatial information system are different depending on usages and users.

For example, the disaster-prevention/disaster-recovery support system described in PTL1 displays the flood-depth layers and is useful for measures against flood damage, but there is a possibility that this system is not suitable for usages or needs different from usages or needs for the measures against flood damage.

In view of the above, one object of this invention is to provide a geospatial information system that can be applied to wider and different usages or user needs.

Another object of this invention is to provide a geospatial information system that can manage wider types of geospatial information.

Still another object of this invention is to provide a geospatial information system that can visually display each piece of geospatial information in a method in which not only a geospatial position thereof but also time is used. The other objects of this invention will be made apparent from the explanation below.

### Solution to Problem

According to one disclosed Embodiment, a geospatial information system which is connected communicably with a user terminal and provides geospatial information to the user terminal includes a database for managing one or more pieces of geospatial content, a content registration unit for receiving the one or more pieces of geospatial content arbitrarily selected by a user and uploaded from the user terminal and registering the received geospatial content in the database, and a content display unit for providing one or more types of geospatial information screens, which display at least a part of the geospatial content registered in the database, to the user terminal.

The geospatial content does not necessarily have to be data on the ground but may be data up in the sky, data under the ground, data under the sea or the like, and the data can be associated with corresponding geospatial spaces, respectively.

The user terminal is not limited to a personal computer but may be a smart phone, a tablet, a head-mount display, a new terminal device which would be born in the future or the like, and structures, functions, or types of usages thereof do not matter.

Each of the geospatial content uploaded from the user terminal has either one of content types in a predetermined plurality of pieces of content types.

When the content registration unit receives one or more pieces of geospatial content uploaded from the user terminal, it identifies each content type of the received geospatial content and registers in the database each of the received geospatial content in a predetermined registration format according to the identified content type.

In the predetermined registration format according to any one type in the one or more content types, geospatial coordinates associated with the geospatial content are included.

If the geospatial coordinates are not included in the received geospatial content, by causing the user to directly specify the geospatial coordinates or by causing the user to specify a spot to be associated with the geospatial content on a map, the content registration unit can associate the geospatial coordinates with the received geospatial content.

The content display unit searches, by using a specified condition arbitrarily specified by the user with respect to predetermined one or more types of search conditions, the database for the geospatial content matching the specified condition, generates a first type of geospatial information screen having a first content display unit displaying a display image of the searched geospatial content overlapping at a position corresponding to the geospatial coordinate on a predetermined map, and provides the first type of geospatial information screen to the user terminal.

The types of the geospatial content include at least an orthoimage and one or more other types.

The type of the geospatial content includes at least a moving image. In a case where the geospatial content uploaded from the user terminal includes a moving image, the content registration unit specifies geospatial coordinate of each of a start point and an end point of the moving image and registers the moving image in the database in a registration format for moving images in which the moving image is associated with each of the geospatial coordinates of the start point and the end point.

The geospatial coordinates registered in association with the moving image do not have to be limited to the start point and the end point but spots in the number considered to be necessary and specified by the user, when a movement locus of photographing of the moving image is to be displayed on a map, may be registered. The movement locus passing through the spot specified by the user is not limited to a straight line but it may be possible to register a shape other than the straight line such as a U-shaped locus indicating a round trip, a polygonal-line shaped or curved-line shaped locus, for example.

The content display unit arranges a realistic-image display unit which plays back and displays the moving image together with the first content display unit in the first type of geospatial information screen, when the first type of geospatial information screen is to be generated.

The content display unit further displays a camera position mark at a position between the geospatial coordinate of the start point and the geospatial coordinate of the end point of the moving image on the map of the first content display unit.

The content display unit further moves the camera position mark from the start point to the end point in accordance with a playback time point at playback of the moving image in the realistic-image display unit.

The camera position mark may be such a mark that indicates not only a camera position at photographing but also a sight direction of the camera.

The types of the geospatial content can include at least a panoramic image (a celestial sphere image, a 360-degree image, or an image obtained by photographing an angular range extremely wider than a normal photographic image). When the panoramic photo is included in the geospatial content uploaded from the user terminal, the content registration unit can specify the geospatial coordinate indicating a photographing position of the panoramic photo and register it in the database.

If the geospatial coordinate is not included in the received panoramic photo, the content registration unit can register it in the database in a registration format for panoramic photos associated with the geospatial coordinates by such a method that the user is caused to specify the coordinate of the photographic spot on the map or the like.

The types of the geospatial content can include at least DSM (Digital Surface Model). The DSM refers to a file which expresses three-dimensional data formed of an elevation of a geospatial feature surface in a two-dimensional mesh format. When the DSM is included in the geospatial content uploaded from the user terminal, the content registration unit can specify the geospatial coordinate defining a planar geospatial area corresponding to the DSM and register it in the database. If the geospatial coordinates of the geospatial areas corresponding to the received DSM are not included, the content registration unit can perform registration in the database in the registration format for DSM associated with the geospatial coordinates by such a method that the user is caused to specify the geospatial coordinates on the map or the like. The handling similar to that may be performed also for the other types of geospatial models such as DEM (Digital Elevation Model), DTM (Digital Terrain Model), DHM (Digital Height Model), DLM (Digital Land Use Map) or the like. Moreover, it may be so configured that, by using a large number of photo images of a geospatial area uploaded from the user terminal, this system can automatically generate the geospatial model as above of the geospatial area inside thereof and register it as above. Those geospatial models may be arranged on the same layer as the ortho-map image and shown to the user as an image. Alternatively, it may be so configured that icons of those geospatial models are displayed by being overlapped on the ortho-map image, and when the user clicks the icon, a viewer for the model is activated and shows the model as an image to the user.

The types of the geospatial content can include at least 3D (three-dimensional) point-group data. The 3D point-group data refers to a set of pieces of point data having three-dimensional coordinates. When the geospatial content uploaded from the user terminal include the 3D point-group data, the content registration unit can specify a geospatial coordinate indicating a geospatial area corresponding to the 3D point-group data and register it in the database. The 3D point-group data may also be configured to be capable of handling similar to the aforementioned handling of the DSM.

The types of the geospatial content can include at least 3D (three-dimensional) mesh data. The 3D mesh data refers to three-dimensional data constituted by a polygon with each point of the three-dimensional point-group data as an apex, and a surface of the polygon is called a mesh. When the geospatial content uploaded from the user terminal include the 3D mesh data, the content registration unit can specify a geospatial coordinate indicating a photographed area of the 3D mesh data and register it in the database. The 3D mesh data may also be configured to be capable of handling similar to the aforementioned handling of the DSM.

The types of the geospatial content can include at least labels. The label refers to geospatial content constituted by an arbitrary spot specified by the user on a map and information accompanying the spot. The information accompanying the spot is a label name, a note, a file, an URL link or the like. The content registration unit can specify the geospatial coordinate which manages the label and register the label in the database by associating it with the geospatial coordinate by causing the user to specify the spot on which the label is to be arranged on a map.

In the geospatial content, the orthoimage, the DSM, the 3D point-group data, the 3D mesh data and the like do not necessarily have to be input from an outside, but it may be so configured that this system generates those types of data by executing SfM/MVS analysis, for example, on the basis of an image or a moving image registered in the database.

In the geospatial content, a panoramic photo does not necessarily have to be input from the outside, but it may be so configured that this system generates the panoramic image by joining those images on the basis of an image or a moving image registered in the database.

The content display unit may be configured such that a user is caused to specify a measurement area on an orthoimage, a distance, an area, a volume or the like of the specified area are measured, and the measurement result is displayed by being overlapped on the orthoimage in a format of a graph or the like, for example.

The content display unit may be capable of switching a background image to be displayed to arbitrary geographic content (any one of orthoimages at plural timings or a geographic model image such as the DSM instead of the orthoimage, for example), when the user specifies the measurement area or when the measurement result is to be displayed. As a result, the user can grasp a situation of the measurement target area in more detail or more accurately.

The measurement area and the measurement result themselves can be registered in the database as the geospatial content. As a result, the measurement area and the measurement result can be searched by using arbitrary search means similarly to the other pieces of the geospatial content registered by the user. Moreover, when the measurement area and the measurement result are to be registered in the database, similarly to the other pieces of geospatial content, arbitrary comments input by a user or a tag may be able to be added.

Regarding the measurement area, even after the measurement area is registered in the database, the geospatial coordinate such as an apex or the like thereof may be capable of being freely updated by a user. The updated apex coordinates may overwrite and be preserved in the database.

The content display unit can cause the user to select one or more pieces of geospatial content on the first type of geospatial information screen and can cause the user to select an overlap display format or a divisional display format as a form for displaying the geospatial content. As the selection method, a method that a user sequentially selects each of geospatial content and a method that a user selects one or more pieces of geospatial content present in the geospatial area simultaneously by specifying a certain geospatial area can be employed.

When the user selects one or more pieces of geospatial content and selects the divisional display format on the first type of geospatial information screen, the content display unit generates a second type of geospatial information screen having a second content display unit which displays the selected geospatial content in the divisional display format capable of browsing in contrast and provides the second type of geospatial information screen to the user terminal.

It may be so configured that the content display unit can divide the geospatial information screen into the number of pieces of the geospatial content present in the geospatial area selected by the user on the map and display those pieces of geospatial content. The number of divisions of the geospatial information screen is not limited to 2, but the geospatial content in the number desired by the user can be displayed in the divisional display format.

When the plurality of panoramic photos are to be displayed in the divisional display format, it may be so configured that, in a form of following an operation that the user changes a sight direction of any one of the panoramic photos, the content display unit can also automatically change the sight direction of the other displayed panoramic photos.

When the plurality of panoramic photos are to be displayed in the divisional display format, it may be so configured that, when a user specifies an arbitrary spot on a map, the content display unit can change the sight direction of the plurality of displayed panoramic photos to be directed to a direction toward the spot specified by the user.

When there are a plurality of pieces of geospatial content at different timings in a geographic area, it may be so configured that the content display unit can not only display those pieces of geospatial content but also analyze a difference between the pieces of geospatial content at different timings and display the difference analysis result.

When the geospatial content at plural timings has positional errors, respectively, the content display unit may automatically correct the positional error of the geospatial content by extracting overlapping feature points through respective analysis of the geographic content, and by performing local iterative operations so that the difference of the overlapping feature points becomes the minimum before performing the difference analysis.

When the geospatial content at plural timings has the positional errors, respectively, the content display unit does not necessarily have to execute the entire difference analysis automatically but may correct the positional errors of the geospatial content semi-automatically by clicking the overlapping feature points in the geospatial content by a person on the map or by directly specifying a numerical value from the screen or a file and by performing the local iterative operations so that the difference of the overlapping feature points becomes the minimum.

The content registration and display units can not only register and display geospatial content but also may be capable of registering and displaying the analysis result obtained by executing an image analysis or an AI analysis with the geospatial content as an input as another geospatial content.

When there are image analysis results or AI analysis results at plural different timings in a geospatial area, the content display unit may be capable of analyzing a difference between the image analysis result or the AI analysis result at those different timings and of displaying the difference analysis result.

It may be so configured that the analysis result is not only displayed by the content display unit but can also be output to an outside so as to be imported to an external system.

When one or more pieces of geospatial content uploaded from the user terminal are received, the content registration unit specifies time and date of each of the received geospatial content, causes the user to set arbitrary one or more tags to each of the received geospatial content, and registers each of the received geospatial content in the database in a predetermined registration format according to each content type associated with the identified time and date and the set tags.

The predetermined one or more types of search conditions include at least a period condition for narrowing the geospatial content to be searched by the time and date and a tag condition for narrowing the geospatial content to be searched by the tag.

The content registration unit can register one or more pieces of geospatial content uploaded from the user terminal in association with one or more projects arbitrarily set by the user.

The content registration unit can cause the user to select a first registration method for registering one or more pieces of geospatial content in association with one project and a second registration method for registering a plurality of pieces of geospatial content in association with a plurality of the projects.

When the second registration method is selected and the plurality of pieces of geospatial content are uploaded from the user terminal, the content registration unit automatically classifies the uploaded plurality of pieces of geospatial content into a plurality of groups, causes the user to make desired modification for each of the classified plurality of groups, causes the user to set a project for each of the classified plurality of groups, and registers the geospatial content belonging to each of the classified plurality of groups in association with the set project in the database.

The content display unit receives a request to open the project desired by the user from the user terminal and generates the first type of geospatial information screen by using the geospatial content in the database associated with the desired project and provides it to the user terminal.

The first type of geospatial information screen has a tag editing unit for the user to edit each of the tags of the geospatial content displayed on the first type of geospatial information screen.

### BRIEF DESCRIPTION OF DRAWINGS

FIG. 1 is a diagram illustrating an entire hardware configuration of a geospatial information system according to an Embodiment.

FIG. 2 is a diagram illustrating a configuration example of a management table stored in a database.

FIG. 3 is a diagram illustrating an example of a display screen of a project.

FIG. 4 is a diagram illustrating an example of a divisional display screen of a plurality of pieces of content.

FIG. 5 is a flowchart illustrating a flow of control of opening a project by a content display unit.

FIG. 6 is a flowchart illustrating a flow of control of searching and displaying content by the content display unit.

FIG. 7 is a flowchart illustrating a flow of control of switching between divisional display and overlap display of content by the content display unit.

FIG. 8 is a diagram illustrating an example of a screen displaying a moving image.

FIG. 9 is a flowchart illustrating a flow of processing of controlling a camera position mark in accordance with a playback time point by the content display unit.

FIG. 10 is a diagram illustrating a flow of processing of controlling the playback time point of the moving image in accordance with the camera position mark by the content display unit.

FIG. 11 is a diagram illustrating an example of a screen for selecting a registration method of content.

FIG. 12 is a diagram illustrating an example of a screen for selecting content desired to be registered.

FIG. 13 is a diagram illustrating an example of a screen of a selection result of the content desired to be registered.

FIG. 14 is a diagram illustrating an example of a screen of a result of automatic grouping of the selected content.

FIG. 15 is a diagram illustrating an example of a screen for modifying a group of content.

FIG. 16 is a diagram illustrating an example of a screen for registering a project for each group.

FIG. 17 is a flowchart illustrating a flow of control of registration of content by a content registration unit.

FIG. 18 is a flowchart illustrating a flow of control in more detail at content upload by the content display unit.

FIG. 19 is a flowchart illustrating a flow of a control example of calculation processing of a content analysis tool.

FIG. 20 is a flowchart illustrating a flow of a mode of controlling a sight direction of panoramic images by the content display unit, when a plurality of the panoramic images are displayed in a divisional display format.

FIG. 21 is a flowchart illustrating a flow of another mode of controlling the sight direction of the panoramic images by the content display unit, when the plurality of panoramic images are displayed in the divisional display format.

FIG. 22 is a diagram illustrating a flow of control of positioning among the plurality of pieces of geospatial content present in the same geospatial area.

FIG. 23 is a diagram illustrating an example of a project screen displaying the panoramic image.

### DESCRIPTION OF EMBODIMENTS

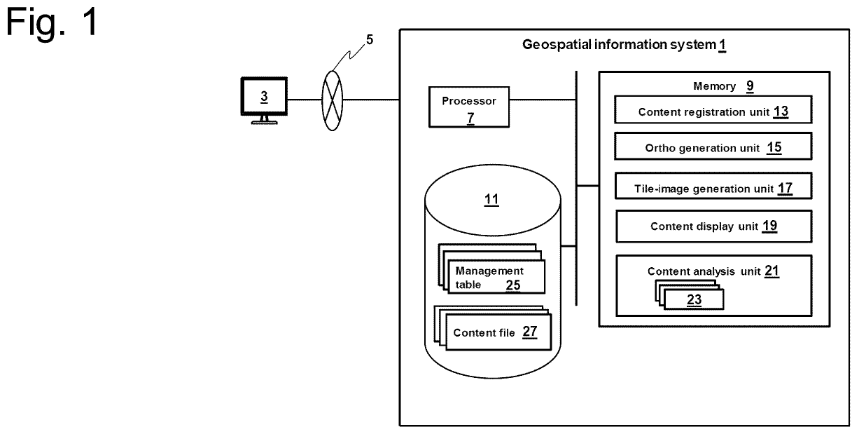

FIG. 1 illustrates an entire hardware configuration of a geospatial information system according to an Embodiment.

A geospatial information system 1 according to the Embodiment is connected capable of communication to one or more user terminals 3 via a communication network 5 and provides geospatial information to the user terminal 3. That is, the geospatial information system 1 can receive various types of geospatial content from the user terminal 3 and store and register the received geospatial content. And the geospatial information system 1 can provide the geospatial information in various modes to the user terminal 3 such that the registered geospatial content is displayed by being overlapped on a map, a plurality of pieces of geospatial content are displayed in contrast, detailed information of the geospatial content is displayed and the like. Types of the geospatial content that can be handled by the geospatial information system 1 (hereinafter, abbreviated as content) include, for example, a single still image photographed by a camera at an arbitrary spot (hereinafter, referred also to as a mono image), 360-degree image for panoramic display and/or celestial sphere image, a moving image, an orthoimage of an arbitrary region, a plurality of still images for creating the orthoimage, three-dimensional or two-dimensional model data of an arbitrary geospatial object or a region (DEM (Digital Elevation Model), DTM (Digital Terrain Model), DHM (Digital Height Model), 3D point-group data (a set of point data having three-dimensional coordinates), 3D mesh data (three-dimensional data constituted by a polygon with each point of the three-dimensional point-group data as an apex), DLM (Digital Land Use Map) or the like), analysis data obtained by analyzing those pieces of content and the like, but they are not limiting. The aforementioned analysis data can be a difference analysis result among a plurality of pieces of the registered geospatial content, an image analysis result, an AI analysis result obtained by analyzing the geospatial content by artificial intelligence (AI), a difference analysis result among a plurality of image analysis results and/or a difference analysis result among a plurality of AI analysis results and the like, for example.

The geospatial information system 1 includes a processor 7, a memory 9, and a database 11. The memory 9 stores various computer programs, and when the processor 7 executes those computer programs, various functions for providing the geospatial information which will be described below in detail are realized.

The computer programs in the memory 9 include, for example, a content registration unit 13, an ortho generation unit 15, a tile-image generation unit 17, a content display unit 19, a content analysis unit 21 and the like. The content registration unit 13 is a program which receives content from the user terminal 3 and stores and registers it in the database 11. The ortho generation unit 15 is a program which generates an orthoimage from a plurality of mono images of a registered region. The tile-image generation unit 17 is a program which generates a plurality of tile images for displaying them by a zoom rate desired by the user from display target images such as the orthoimage, the mono image and the like. The content display unit 19 is a program which displays content desired by the user in a mode desired by the user. The content analysis unit 21 is a set of one or more types of content analysis tools 23, and each of the content analysis tools 23 is a program which analyzes a predetermined type of content by a predetermined method for a predetermined purpose.

The database 11 stores and manages one or more types of management tables 25, a file 17 of registered various types of content and the like. The database 11 may also hold one or more types of maps (not shown) (or the map may be received by the geospatial information system 1 via the network 5 from an external map providing system on a real-time basis, when the map is to be displayed).

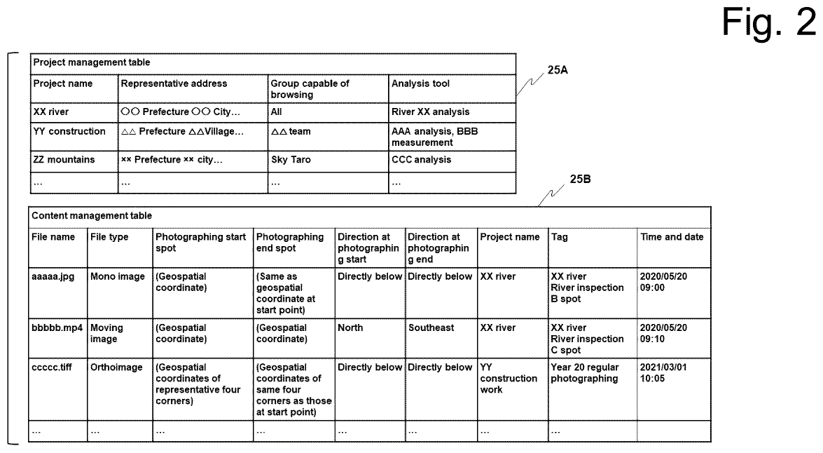

FIG. 2 illustrates a configuration example of the management table 25 stored in the database 11.

In FIG. 2, a project management table 25A for managing a project and a content management table 25B for managing content are exemplified (other than them, though not shown, there can be a user management table for managing a user).

In the project management table 25A, one or more projects set by the user are registered in a registration format for project. That is, in the project management table 25A, for each of the projects (that is, a purpose or a work for which the user uses the geospatial information system 1), a name of the project, a place on a map or address notation of the region to be displayed in the project, a user group who can browse the project, a content analysis tool which can be used for the project and the like are registered.

In the content management table 25B, one or more pieces of content (content files) uploaded from the user terminal 3 are registered in predetermined registration formats according to the respective content types. That is, in the content management table 25B, a file name, a file type (that is, a type of the content), a geospatial coordinate of a photographing start spot (latitude, longitude, altitude), a geospatial coordinate of a photographing end spot (latitude, longitude, altitude), a direction of a camera at start of photographing, a direction of a camera at end of photographing, a name of the project for which the content is used, a tag given to the content (concepts related to use purposes, usages, characteristics, places, utilities, values and the like of the content arbitrarily set by the user), time and date of the content (at photographing or at registration) of the content and the like are registered for each content received (uploaded) from the user terminal 3. Note that, when the content type is a mono image or an orthoimage, the same photographing position and direction are registered for the start and the end of the photographing, but in the case of the moving image, different photographing positions and directions can be registered for the start time and the end time of the photographing. Moreover, in the case of the orthoimage, geospatial coordinates of spots at representative four corners of the orthoimage are registered for the geospatial coordinate of the photographing start spot.

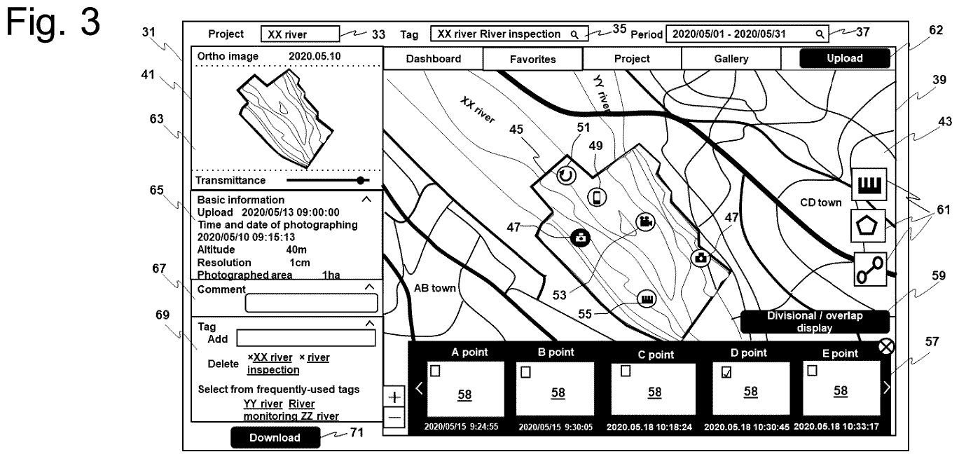

FIG. 3 illustrates an example of a project screen displayed by the geospatial information system 1 on the user terminal 3.

When the user logs in to the geospatial information system 1 and opens one of the projects which the user can browse, the project screen for performing a work of the project is displayed on the user terminal 3. There are plural types of the project screens, but the one illustrated in FIG. 3 is one of representative project screens.

On an upper part of a project screen 31 exemplified in FIG. 3, there are a project name column 33, a tag search column 35, and a period search column 37. At a center of the project screen 31, there is a content display frame 39, and there is a detailed display frame 41 on the left thereto. Moreover, there is an upload button 62 on an upper part adjacent to the content display frame 39, and there is a download button 71 on a lower part adjacent to the detailed display frame 41.

In the project name column 33, a name of the project which is currently open is displayed. In the tag search column 35, by inputting an arbitrary tag and searching only the content to which the tag is given from the database 11, the user can cause them to be displayed in the content display frame 39. In the period search column 37, by inputting an arbitrary period (a start date and an end date of the period) and by searching only the content to which the time and date in that period are given from the database 11, the user can cause them to be displayed in the content display frame 39. By searching the content by selecting or combining different types of search conditions such as the tag and the period as above, the user can cause content not required for the work in terms of the concept and the time and date not to be displayed in the content display frame 39.

In the content display frame 39, the display format of the content can be switched between two types, that is, overlap display and divisional display. The switching can be performed by clicking a divisional/overlap display switching button 59 on the content display frame 39.

In the example in FIG. 3, a case in which the overlap display format is currently selected is shown. In the overlap display format, as a background of the content display frame 39, a predetermined map 43 (one type of map selected by the user from plural types of maps prepared in advance (maps of different images such as illustrations from different vendors, satellite photos and the like, for example)) is displayed. The place on the map or the region displayed at the beginning when the project was opened is the place or the region corresponding to a representative spot of the project registered in the project management table 25A (FIG. 2) (after that, the user can freely change the displayed place or region by scrolling or the like). On the map 43 as the background, the pieces of content registered by the user (and searched by the tag and/or the period) are displayed by being overlapped.

In that case, as shown in FIG. 3, an orthoimage 45 of the region is displayed as its realistic image being placed on the map 43 (a set of tile images used for display of a realistic image is different depending on a zoom rate). The pieces of content other than the orthoimage (a mono image, an image for panoramic display, a moving image, three-dimensional model data, analysis result data and the like, for example) are displayed not as the realistic image but in a format of an icon 47 (mono image photographed by a normal camera), 49 (mono image photographed by a smartphone), 51 (360-degree still image for panoramic display), 53 (moving image), 55 (analysis result data) indicating the respective content types by being placed on the map 43 or the orthoimage 47. Therefore, a front-rear arrangement relation in which the pieces of content are displayed is, first, from a rear surface side to a front side, the map 43 on a rearmost surface, then, the orthoimage 45, and the icons 47, 49, 51, 53, 55 of the other pieces of content on a frontmost surface in order. This display order has no relation with an order of time and date of the content. A display position on the map of each content (or its icon) is a position corresponding to the geospatial coordinate of each content registered in the content management table 25B.

Moreover, when a plurality of the orthoimages are overlap-displayed, there is no front-rear arrangement relation among those orthoimages, but each of the orthoimages is displayed with clearness according to transparency set by the user for the respective orthoimages.

Moreover, when the icons of the pieces of content other than the orthoimages are to be displayed by overlapping each other, with the front-rear arrangement in the order of time and date (an icon with newer time and date overlaps an older icon, for example), for example, and even the icons of the totally same geospatial coordinates are displayed by slightly displacing positions thereof so that the icons behind are not hidden.

Instead of the display order from the rear surface to the front surface such as the map, the orthoimage, and the icons of the other pieces of the geospatial content as described above, the following display order may be employed. That is, a map is displayed on a layer on the rearmost surface side, an orthoimage and an actual image of three-dimensional model data are displayed on an intermediate layer on that, and the icons of the other pieces of geospatial content are displayed on a layer on the frontmost surface side. Transparency of each of the orthoimages and the actual image of the three-dimensional model data on the intermediate layer can be adjusted, whereby a mutual relation can be visually recognized, which is preferable.

Moreover, if analysis data is included in the geospatial content to be displayed, the following display order may be employed. That is, a map is displayed on a layer on the rearmost surface side, the orthoimage (or the orthoimage and the actual image of the three-dimensional model data) are displayed on the intermediate layer on that, the analysis data is displayed on the second intermediate layer on further top of that, and the icons of the other pieces of geospatial content are displayed on the layer on the frontmost surface side on that.

By overlap-displaying a plurality of pieces of the content in the mode as above, the user can easily grasp what content is located where on the map.

Moreover, if the user desires, a list 57 of the pieces of content displayed on the map 43 of the content display frame 39 can be displayed on the frontmost surface of the content display frame 39. In the content list 57, thumbnail images 58 (in FIG. 3, substances of the thumbnail images are not shown) of the content displayed on the map 43 are displayed. When the user selects one or more arbitrary pieces of content on the map 43, the thumbnail image 58 of the selected content is selected also on the display content list 57 (a check mark is added, for example). To the contrary, if the user selects arbitrary one or more thumbnail images 58 on the display content list 57, the selected pieces of content are selected also on the map 43 (a display color of the icon of the selected content or the orthoimage is changed, for example). As a result, the user can confirm what content is located where on the map more easily.

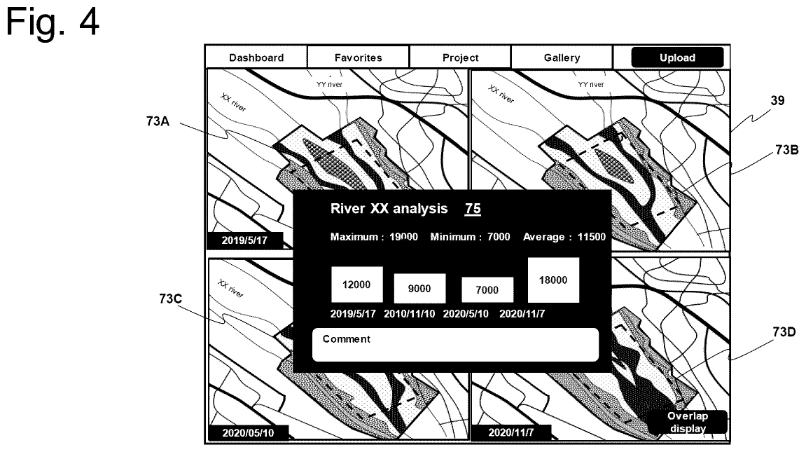

Furthermore, when the user clicks the divisional/overlap display switching button 59 on the content display frame 39, the display format of the content display frame 39 is switched from the overlap display to the divisional display (or opposite to that). FIG. 4 illustrates a display example of the content display frame 39 when it is switched to the divisional display format. The example in FIG. 4 illustrates a display example of a case in which, after the user selected four pieces of content (orthoimages of substantially the same region with different photographing time and date, for example) 73A to 73D in advance at the time of the overlap display format exemplified in FIG. 3, the content display frame 39 is switched from the overlap display to the divisional display. As shown in FIG. 4, in the divisional display format, the substances of the plurality of pieces of content selected by the user are displayed in contrast. Moreover, when analysis result data 75 is present with regard to the selected pieces of content 73A to 73D, the substances of the analysis result data 75 are also displayed together. As a result, the user can easily grasp a difference or a change among the selected plurality of pieces of content visually and numerically.

Moreover, as exemplified in FIG. 4, in the case where the plurality of orthoimages 73A to 73D are displayed in contrast in the divisional display format, when the user specifies an arbitrary spot, a line segment connecting two spots or an area with three spots or more as apexes on the one orthoimage (73A, for example) (in the example in FIG. 4, a rectangular area indicated by a broken line was specified by the user), the spot, the line segment or the area with the same geospatial coordinate as those specified by the user is automatically identified and displayed also on the other orthoimages 73B to 73D. And when the three-dimensional model data generated in the creating process is attached to each of the orthoimages 73A to 73D, various measurements and analyses for the aforementioned spot, line segment or area specified by the user (distance measurement, area measurement, sedimentation measurement, contrast or statistical processing of measured values and the like, for example) by using the respective three-dimensional model data can be made by using any one of the aforementioned analysis tools 23.

With reference to FIG. 3 again, when the user requests detailed information display for an arbitrary one piece of content on the content display frame 39 (by double-clicking an icon or a thumbnail image of the content, for example), detailed information of the content is displayed in the detailed display frame 41. FIG. 3 illustrates a case in which the detailed information of the orthoimage 45 is displayed as an example. Types of a plurality of columns in the detailed information displayed in the detailed display frame 41 are different depending on the type of content, but as a column in common to any content types, there are a realistic image column 63, a basic information column 65, a comment editing column 67, a tag editing column 69 and the like.

In the realistic image column 63 of the content, a realistic image of the content is displayed. This realistic image can be displayed by a full-screen display or in the other sizes desired by the user. In the case of the orthoimage, the user can set transmittance of the orthoimage in this column 63. In the case of a moving image, the moving image can also be played back in this column 63.

In the comment editing column 67, the user can input and add an arbitrary comment for the content or modify an existing comment and register the comment. In the tag editing column 69, the user can input an arbitrary tag to the content and additionally register a new tag or delete an existing registered tag or the like.

Moreover, by clicking the download button 71, a file of the content displayed in the detailed display frame 41 can be downloaded from the geospatial information system 1 to the user terminal 3.

Moreover, by clicking the upload button 62, an arbitrary content file can be uploaded from the user terminal 3 to the geospatial information system 1.

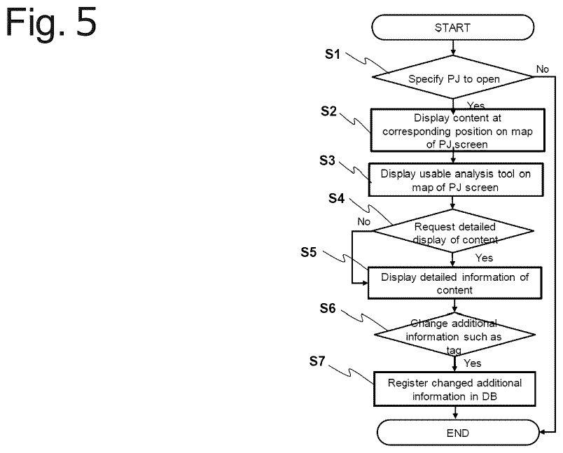

FIG. 5 illustrates a flow of control of displaying the project screen 31 by opening the aforementioned project by the content display unit 19 (FIG. 1).

As shown in FIG. 5, when the user specifies a project to be opened (Step S1), the project screen 31 of the project as exemplified in FIG. 3 is displayed on the user terminal 3, and in the content display frame 39 in the screen 31, a map specified by the user is displayed as a background, and various types of registration content (the orthoimage and icons of the other types of content or the like) associated with the project (the project was registered on the content management table 25B) are displayed by being overlapped on the map (S2). Each content is displayed at a position on the map corresponding to the geospatial coordinate of the content. As described above, the front-rear arrangement relation of the content is in the order of the map, the orthoimage, and the other content icons from the rear surface to the front surface. Moreover, in the content display frame 39, the icon of the analysis tool 23 (registered for the project on the project management table 25A) used in the project is also displayed (S3).

When the user requests detailed information display of an arbitrary one piece of content in this state (S4), the detailed information of the content is displayed in the detailed display frame 41 (S5). The user can update the registration information in the content management table 25B through editing of the detailed information of the various columns displayed in the detailed display frame 41 (S6), thereby adding, changing, deleting and the like of additional information such as a tag given to the content or the like (S7).

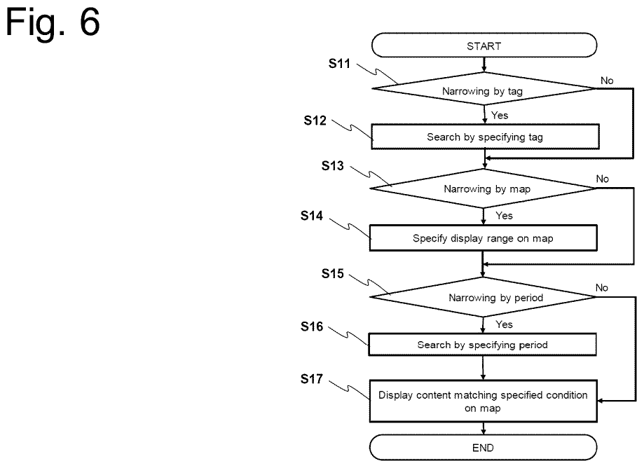

FIG. 6 illustrates a flow of control of searching and displaying the content on the project screen 31 by the content display unit 19 (FIG. 1).

As shown in FIG. 6, when the user specifies an arbitrary tag and requests search (narrowing) in the tag search column 35 on the project screen 31 (FIG. 3) (S11), only the content to which the tag is given is searched from the pieces of content associated with the project (S12). When the user specifies a display range of the map as an arbitrary area by scrolling the map displayed in the content display frame 39, by zooming, or selecting an arbitrary area on the map (S13), only the content present in the specified area is searched (S14) from the content associated with the project. Moreover, when the user requests search (narrowing) by specifying an arbitrary period in the period search column 37 (S15), from the content associated with the project, only the content to which the time and date contained in the period are given is searched (S16).

When narrowing (search) is performed with one or more specified conditions combining one type or two or more types of three types of search conditions such as the tag, the map display range and the period as above, only the content matching those specified conditions are selected from the pieces of content associated with the project, and only the selected content is displayed on the map of the content display frame 39 (S17).

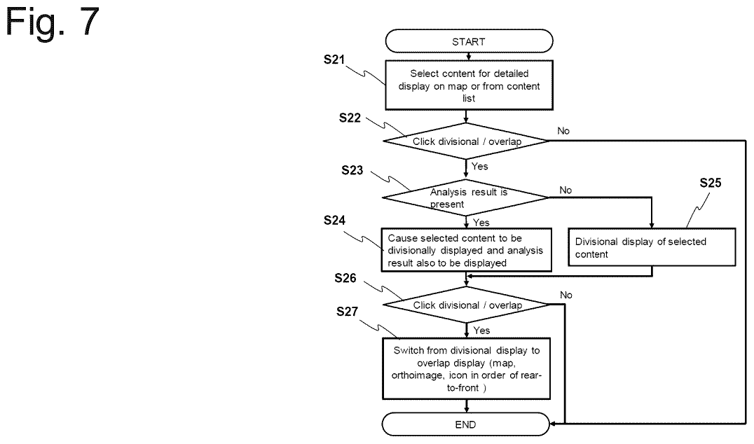

FIG. 7 illustrates a flow of control of switching the display format in the content display frame 39 on the project screen 31 by the content display unit 19 (FIG. 1) between the divisional display and the overlap display.

As shown in FIG. 7, when the content display frame 39 of the project screen 31 (FIG. 3) is in the overlap display format, if the user selects one or a plurality of pieces of content on the map in the content display frame 39 or from the content list (S21) and then, clicks the divisional/overlap display switching button 59 (S22), data of the analysis result related to the selected content is searched from the database 11 (S23), and if there is analysis result data, the realistic image of the selected content is displayed in the divisional display format together with the analysis result data (S24). If there is no analysis result data, the realistic image of the selected content is displayed in the divisional display format capable of being browsed in contrast (S25).

After that, if the user clicks the divisional/overlap display switching button 59 (S26), the display format of the content display frame 39 is switched to the overlap display (S27). After that (though not clearly illustrated in FIG. 7), each time the user clicks the divisional/overlap display switching button 59, the overlap display and the divisional display are switched alternately.

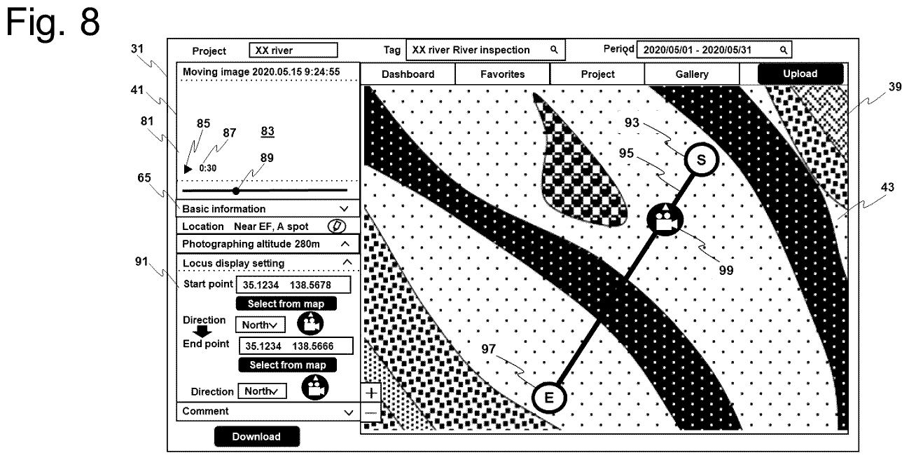

FIG. 8 illustrates a display example when a moving image is displayed on the project screen 31 as exemplified in FIG. 3.

As shown in FIG. 8, when the detailed information of a moving image is displayed in the detailed display frame 41 on the project screen 31 (by user's double-clicking on the moving image icon 47, for example), a moving image 83 thereof is displayed in a realistic image column 81 on top of the detailed display frame 41. By clicking the playback button 85 below the moving image 83, the moving image 83 can be played back. Moreover, a playback time point (playback time from a start frame) display 87 of the moving image 83 is indicated, and a playback time point mark 89 is displayed also on a playback control bar.

When the moving image is displayed in the detailed display frame 41 as above, a locus setting column 91 is displayed in the detailed display frame 41. In this locus setting column 91, a geospatial coordinate of each of a start point (photographing start position) and an end point (photographing end position) of this moving image and a direction of a camera are displayed (these pieces of information can be set at content registration, which will be described later), and the user can also change the geospatial coordinates of the start point and the end point and the camera direction in the locus setting column 91.

Moreover, in this case, in the content display frame 39, on the geospatial coordinate of each of the start point and the end point of this moving image, a start point mark 93 and an end point mark 97 are automatically displayed, and a locus mark 95 connecting the start point mark 93 and the end point mark 97 by a straight line-segment, for example, is also automatically displayed. As the locus mark 95, a movement locus of the camera at photographing of a moving image is expressed approximately. Note that, in a case where the movement locus of the camera having photographed the moving image is a curved line or a polygonal line, it may be so configured that coordinates of not only the start point and the end point but of one or more passing points on the movement locus can be also set by the user. In that case, it may be so configured that the locus mark 95 of a polygonal line or a curved line reaching the end point via the one or more passing points from the start point in order is displayed.

Moreover, at a position corresponding to the playback time point 87 on the locus mark 95, a camera position mark 99 is automatically displayed. That is, a position obtained by proportionally distributing the entire length of the locus mark 95 by a ratio of the playback time point in the entire playback time length of the moving image is automatically calculated, and the camera position mark 99 is displayed at the position. Therefore, while the moving image is being played back, the camera position mark 99 moves from the start point to the end point along the locus mark 95, whereby the user can grasp from what position on the map the scene being currently viewed by the user was photographed.

Moreover, when the user moves the playback time point mark 89 (playback time point) on the playback control bar of the moving image, the camera position mark 99 on the map is also moved in conjunction with that. Similarly, when the user moves the camera position mark 99 on the map, the playback time point mark 89 (playback time point) of the moving image also moves in conjunction with that.

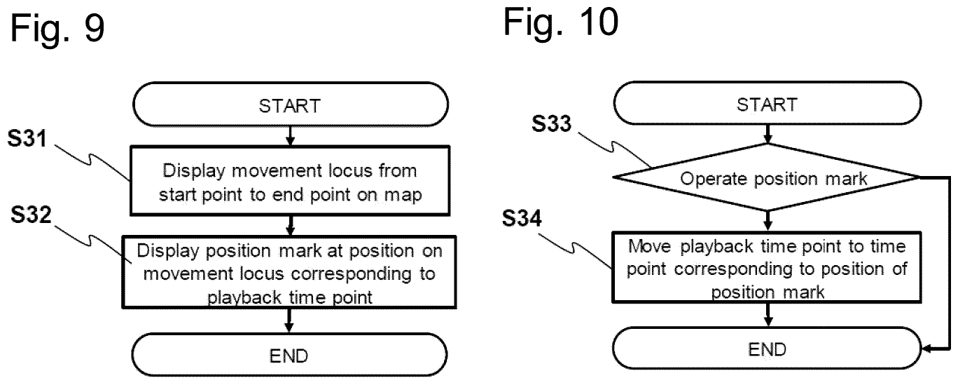

FIG. 9 illustrates a flow of processing of controlling the camera position mark 99 in accordance with the playback time point of the moving image 83 by the content display unit 19 (FIG. 1).

As shown in FIG. 9, on the map in the content display frame 39, the start point mark 93, the end point mark 97, and the locus mark 95 are displayed (S31). Moreover, a position on the locus mark 95 according to the playback time point of the moving image 83 is calculated, and the camera position mark 99 is displayed at that position (S32).

FIG. 10 illustrates a flow of processing of controlling the playback time point of the moving image 83 in accordance with the camera position mark 99 by the content display unit 19 (FIG. 1).

As shown in FIG. 10, when the user moves the camera position mark 99 on the map along the locus mark 95 (S41), the playback time point of the moving image 83 corresponding to the position of the camera position mark 99 is calculated, and an actual playback time point of the moving image is changed to the calculated playback time point (S42).

FIG. 3 will be referred to again. When the user clicks the upload button 62 in the project screen 31, the user can upload various types of content as described above from the user terminal 3 to the map information system 1 and register it.

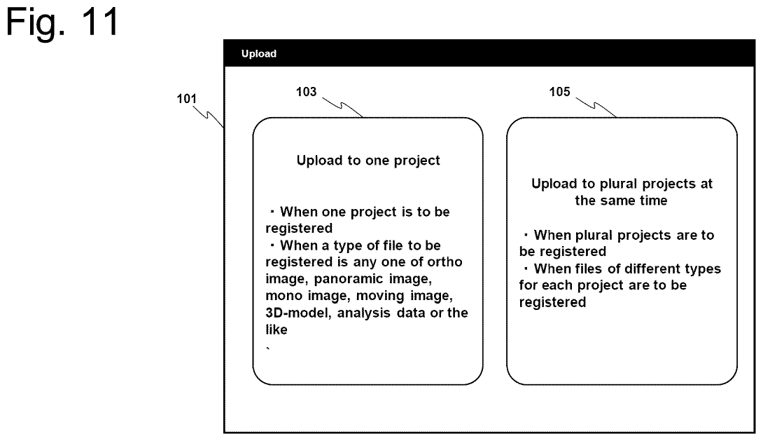

FIG. 11 to FIG. 16 illustrate examples of a series of screens displayed by the geospatial information system 1 on the user terminal 3 at the uploading and registration of the content.

When the aforementioned upload button 62 is clicked, first, a registration-method selection screen 106 as shown in FIG. 11 is displayed. In this screen 106, either one of a method of registering one or more pieces of content in one project and a method of registering a plurality of pieces of content in a plurality of projects can be selected. By clicking a button 103, the former can be selected, while by clicking a button 105, the latter can be selected.

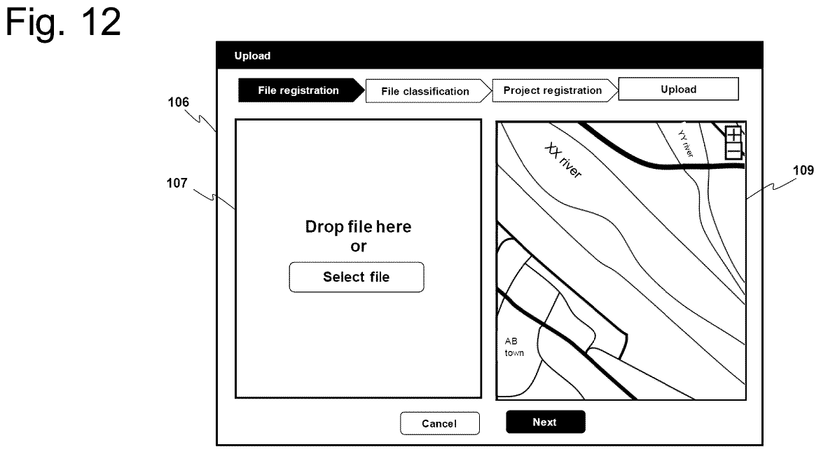

Whichever one of the buttons 103 and 105 is clicked, the control subsequently proceeds to a content selection step, and a content selection screen 106 as shown in FIG. 12 is displayed. In this screen 106, there are a file selection column 107 and a map display column 109. The user can select, by using the file selection column 107, one or more content files desired to be registered in an arbitrary directory of the user terminal 3 or on the network 5. In the map display column 109, a map of an arbitrary region selected by the user or a map of a region containing a geospatial coordinate described in the content file desired to be registered which was selected by the user is displayed.

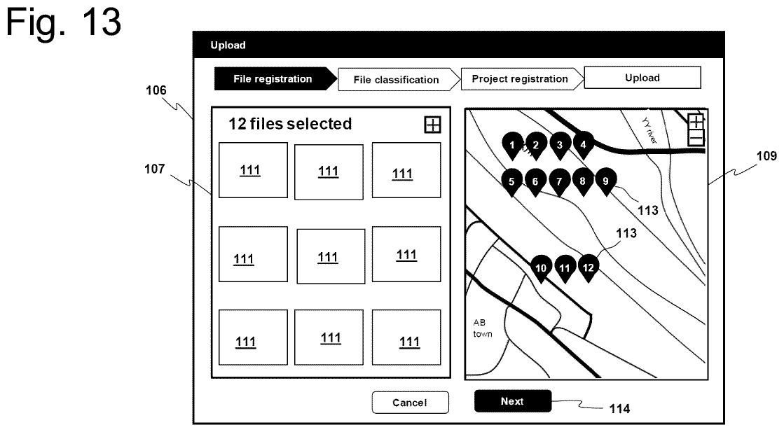

When the user selects one or more content files desired to be registered by using the file selection column 107, as shown in FIG. 13, in the content selection column 107, a list of thumbnail images 111 of the selected pieces of content is displayed. Moreover, at positions corresponding to the geospatial coordinates of the selected pieces of content on the map in the map display column 109, content icons 113 indicating reference numbers of the selected pieces of content are displayed.

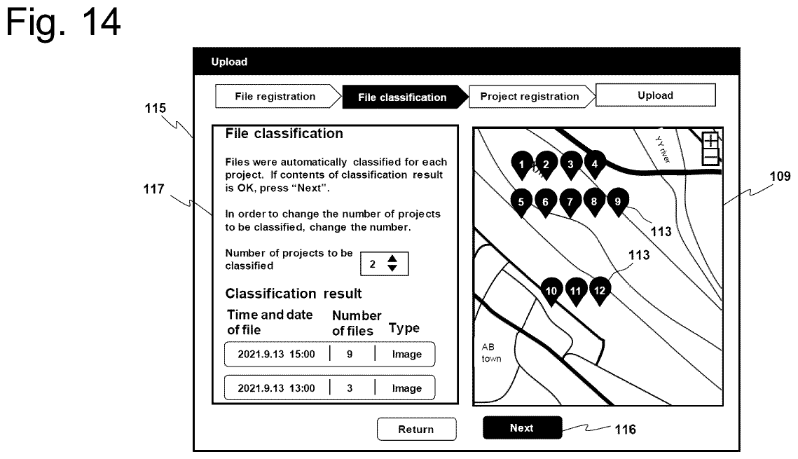

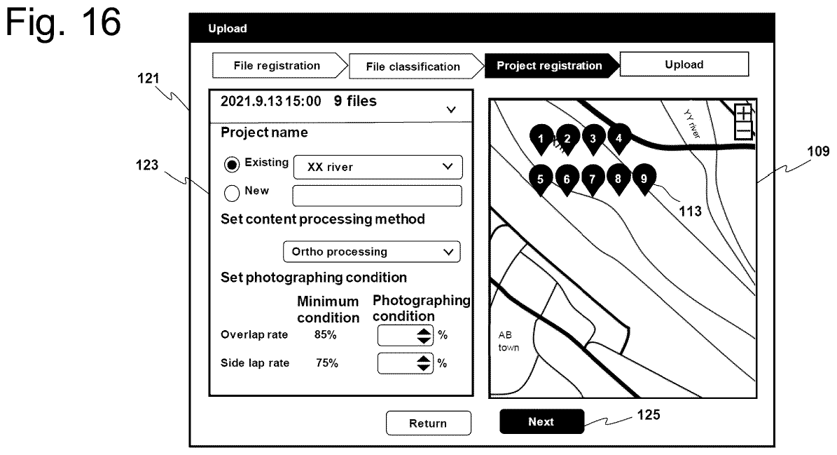

After the content desired to be registered is selected as above, when the user clicks the next button 114, a step to be executed next and a screen to be displayed are different between a case of registration in one project and a case of registration in plural projects. In the former case, the control proceeds to a project registration step, and a project registration screen 121 as shown in FIG. 16 is displayed. On the other hand, in the latter case, the control proceeds to a content classification step, and a content classification screen 115 as shown in FIG. 14 is displayed.

Upon proceeding to the content classification step in the latter case, the content registration unit 13 of the geospatial information system 1 (FIG. 1) automatically classifies the selected pieces of content into a plurality of groups. This classification is to classify the pieces of content presumed to be registered in the same project into the same group and the pieces of content presumed to be registered in different projects into different groups and can be performed by using a machine-learned neural network, for example, on the basis of a type (identifier) of the content file, a geospatial coordinate recorded in the content file, a direction of the camera, time and date of the photographing and the like. The result of this automatic classification is displayed in the content classification screen 115 exemplified in FIG. 14. That is, the result of automatic classification is displayed in the file classification column 117 of this screen 115.

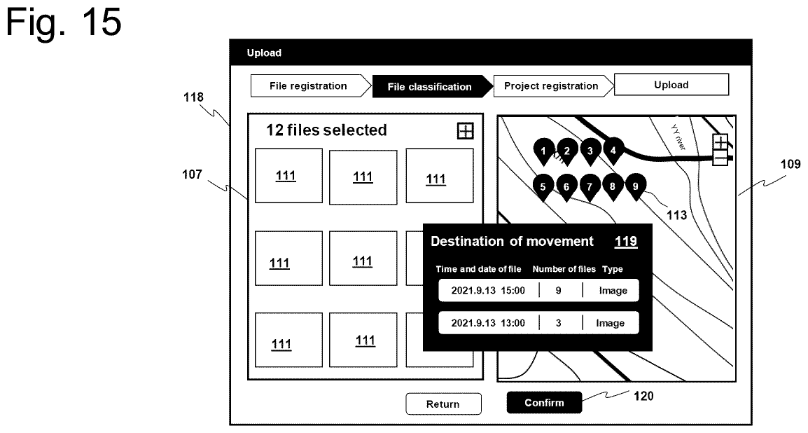

When the user requests modification of the classification result shown in the file classification column 117 of this screen 115, the screen is switched to the classification modification screen 118 as shown in FIG. 15. On this classification modification screen 118, the user selects arbitrary content in the file selection column 107 or the map display column 109 and moves it to an arbitrary group in a movement-destination group box 119, whereby the group classification of the content can be modified. When the user clicks a confirmation button 120 on this screen, the modification result is confirmed, and the screen moves to the content classification screen 115 exemplified in FIG. 14.

When the user clicks a next button 116 on the content classification screen 115 exemplified in FIG. 14, the control proceeds to the project registration step, and the project registration screen 121 as shown in FIG. 16 is displayed.

In the project registration screen 121 exemplified in FIG. 16, for each content group, the icon 113 of content belonging to the group is displayed in the map display column 109, and a project setting column 123 for setting a project, which is a registration destination of those pieces of content, is displayed. In the project setting column 123, the user can set a project name of the registration destination and content processing which should be executed (ortho-imaging processing, tile imaging processing and the like, for example) for the content of the group.

On this project registration screen 121, when the user clicks the next button 125 after making necessary project setting, the content file of the group is uploaded from the user terminal 3 to the geospatial information system 1 and is registered in the project of the registration destination. At that time, the geospatial information system 1 executes the content processing which is set to the uploaded content. Moreover, if the content is a moving image, the geospatial information system 1 causes the user to specify positions of a start point and an end point of the moving image and a direction of the camera on the map in the map display column 109 as illustrated in FIG. 16 (specific screen for that is not shown), and the geospatial coordinates of the start point and the end point and the direction of the camera are also registered with the file of the moving image.

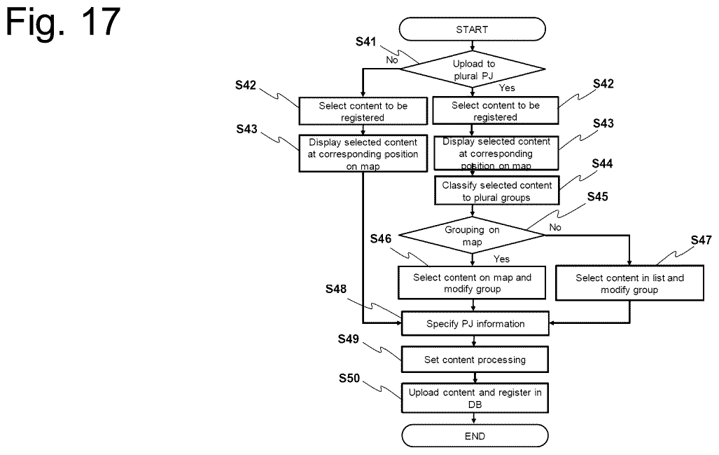

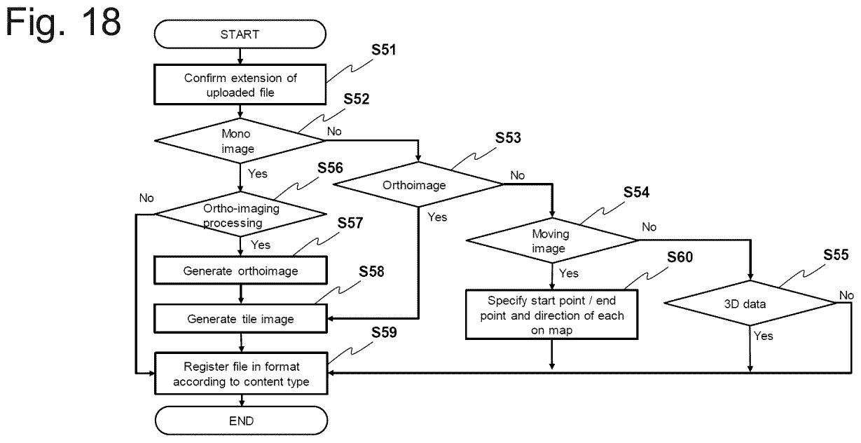

FIG. 17 illustrates a flow of control of registering the content by the content registration unit 13 (FIG. 1) described above.

As shown in FIG. 17, the user selects, on a registration-method selection screen 101 (FIG. 11), whether the registration (upload) destination of the content is one project or plural projects (S41). Whichever of them is selected, after that, the user selects one or more pieces of content desired to be registered by using the content selection column 107 of the content selection screen 106 (FIG. 12) (S42). Then, the icon of the selected content is displayed at a corresponding position on the map of the map display column 109 of the content selection screen 106 (FIG. 12) (S43).

After that, only when the registration to the plural projects is selected at Step S41, automatic group classification of the selected content is performed (S44). After that, the user modifies the automatic classification result. That is, the user causes the classification modification screen 118 (FIG. 15) to be displayed, moves a cursor on the map in the map display column 109 in the screen 118 (Yes at S45), selects arbitrary content on the map and moves it to an arbitrary group in the movement-destination group box 119, whereby the group can be modified (S46). Alternatively, the user moves the cursor to the file selection column 107 in the classification modification screen 118 (FIG. 15) (No at S45), selects arbitrary content from a content list in the column 107, and moves it to an arbitrary group in the movement-destination group box 119, whereby the group can be modified (S47).

After the content to be registered in each project is confirmed as above, the user sets information of each project in the project registration screen 121 (FIG. 16) (S48). Moreover, the user sets processing to be executed for the content on the project registration screen 121 (FIG. 16) (S49).

After the aforementioned setting has been finished, when the user clicks the next button 125 on the project registration screen 121 (FIG. 16), the file of the content to be registered for each project is uploaded together with the aforementioned various types of set information to a geospatial information server 1, stored and registered in the database 11 (S50).

FIG. 18 illustrates a flow of control in more detail of a step of content upload shown at Step S50 in FIG. 17.

As shown in FIG. 18, an extension of the uploaded content file is searched (S51), and a type of the content is identified (S52 to S55). As the type of the content, a mono image (still image), an orthoimage, a moving image, three-dimensional model data are exemplified in FIG. 18, but there can be the other types (for example, 360-degree still image for panoramic display or a moving image with identifier different for each data, camera in an analysis result, a report document related to a spot or a region or the like).

And when the identification result is a mono image (Yes at S52), if ortho-imaging processing is not set for the mono image (No at S56), it is stored and registered in the database 11 in the predetermined registration format for mono image (S59).

Moreover, when the ortho-imaging processing is set for a plurality of mono images obtained by photographing a region by a camera and overlapping each other (Yes at S56), an orthoimage of that region is created from those plurality of mono images (S57), and a tile image for display is created from the orthoimage (S58). And those mono images, orthoimages, and tile images are associated with one another and stored and registered in the database 11 in the predetermined registration format for the respective image types (S59). Note that, in the process of creating the orthoimage at Step S57, three-dimensional model data of that region is usually generated as an intermediate product. This three-dimensional model data may also be associated with the orthoimage or independently of the orthoimage and stored in the database 11 to be registered in the predetermined registration format for the three-dimensional model data (S59).

Moreover, in the case where the aforementioned identification result is the orthoimage (Yes at S53), a tile image for display is created from the orthoimage (S58), the orthoimage and the tile image are associated with each other and are stored and registered in the database 11 in the predetermined registration format for the respective image types (S59).

Moreover, in the case where the aforementioned identification result is a moving image (Yes at S54), on the map display column 109 of the project registration screen 121 (FIG. 16), the user is caused to set positions of a start point and an end point of a movement locus of the camera and a direction of a sight of the camera at photographing of the moving image (S60) (if the movement locus is a polygonal line, a curved line or the like, positions of one or more passing spots on the movement locus may also be set). After that, the moving image is stored and registered in the database 11 in the predetermined registration format for the moving image together with the setting information such as the start point, the end point, the camera direction and the like (S59).

When the uploaded geospatial content is to be registered in the process as above, if one or more geospatial coordinates corresponding to a spot or a region corresponding to the geospatial content are attached to the uploaded geospatial content, the attached geospatial coordinates can be registered in association with the geospatial content. On the other hand, if such geospatial coordinates are not attached to the uploaded geospatial content, by causing the user to input a numerical value of the geospatial coordinate or to specify a spot falling under the geospatial coordinate on the map displayed on the geospatial-information display screen, the geospatial coordinate provided by the user can be registered in association with the geospatial content.

As one or more geospatial coordinates that can be registered in association with each geospatial content, there can be a coordinate of a photographing spot of a mono image, a coordinate of a viewpoint of a panoramic image (photographing spot) and an azimuth of a center position of the entire panoramic image (azimuth of the other predetermined positions of the panoramic image may also be included), a coordinate of an apex of a profile of the orthoimage, a coordinate of an apex of a profile of a geospatial area in which a three-dimensional model is present, coordinates of a start point and an end point of a movement locus of a camera from start to end of photographing of a moving image and a passing point as necessary, a geospatial coordinate of content to be analyzed of analysis data and the like.

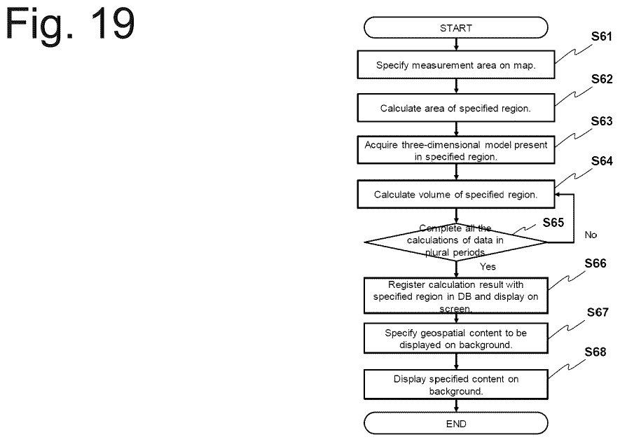

FIG. 19 illustrates a flow of a control example of a tool for measuring an area and a volume of a geospatial area as an example of the content analysis tool 23.

As shown in FIG. 19, when the user specifies a desired geospatial area on the orthoimage map displayed on the content display frame 39 (S61), a planar area of the specified area is calculated by the tool by using the geospatial coordinate of the apex of the specified area in the orthoimage (S62). Moreover, if there is a three-dimensional model (3D point-group data, 3D mesh data or the like, for example) in the specified area, the three-dimensional model is acquired by the tool (S63), and a volume of the specified area is calculated by using the geospatial coordinates of various points in the specified area of the three-dimensional model (S64).

If there are a plurality of three-dimensional models obtained in a plurality of different periods in the same specified area, the volume of the specified area in the respective periods is calculated by the aforementioned method by using the respective three-dimensional models of those different periods (S65) A calculation result of the area of the specified area and the volume of the respective periods is associated with the geospatial coordinate of the specified area, registered in the database 11 as the geospatial content of the measurement data, and displayed on the geospatial-information display screen in a format of a graph or the like, for example (S66).

This tool further enables the user to select desired geospatial content (an orthoimage or an image of the three-dimensional data in any one of periods in the aforementioned different periods, for example) as the background of the content display frame 39, while the aforementioned calculation result is displayed (S67). When the user selects certain geospatial content as a background, the selected content is displayed as the background (S68). As described above, when a calculation result of a volume of a period different from the area of the specified area is displayed, the user can easily grasp a change in a geospatial state according to the period by causing the desired geospatial content or particularly the geospatial content of the desired period to be displayed as the background.

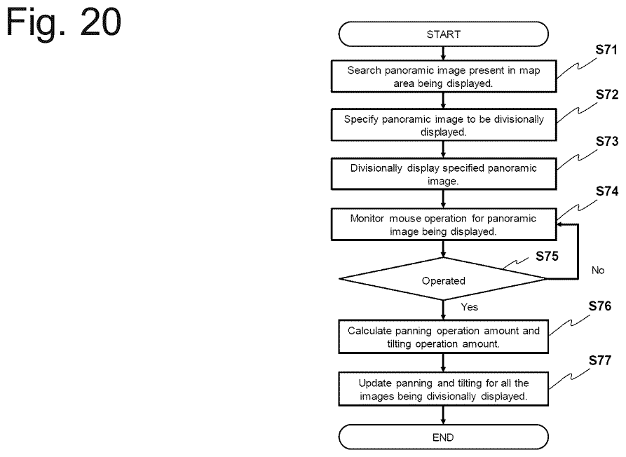

FIG. 20 illustrates a flow of one mode of controlling a sight direction of panoramic images, when a plurality of panoramic images are displayed in the divisional display format. In this mode, such control is executed that the sight directions of the plurality of panoramic images are changed only by the same panning (left-right swing of the sight) angle and tilting (up-down swing of the sight) angle.

As shown in FIG. 20, a panoramic image (a panoramic photo image, for example) present in a map area displayed in the content display frame 39 is searched from the database 11 (S71). By specifying a plurality of the panoramic images that the user desires to be displayed in the divisional display format from those searched panoramic images (S72), the specified plurality of panoramic images are displayed in the content display frame 39 in the divisional display format (S73).

A mouse operation by the user for the plurality of displayed panoramic images is monitored (S74), and when the mouse operation for any one of the panoramic images is detected (S75), a panning operation amount and a tilting (up-down swing of the sight) operation amount of the mouse operation are calculated (S76). Then, the panning of the calculated panning (up-down swing of the sight) amount and the tilting of the calculated tilting operation amount are simultaneously applied to all the displayed panoramic images (S77), and the sights of all the panoramic images are simultaneously changed only by the same panning angle and the same tilting angle.

Note that, at the beginning of the display of the plurality of panoramic images at Step S73, it can be so controlled that the sight directions of all the panoramic images are aligned in the same azimuth such as north, for example, and in that case, by the process indicated in FIG. 20, the sight directions of all the displayed panoramic images can be aligned in the same direction.

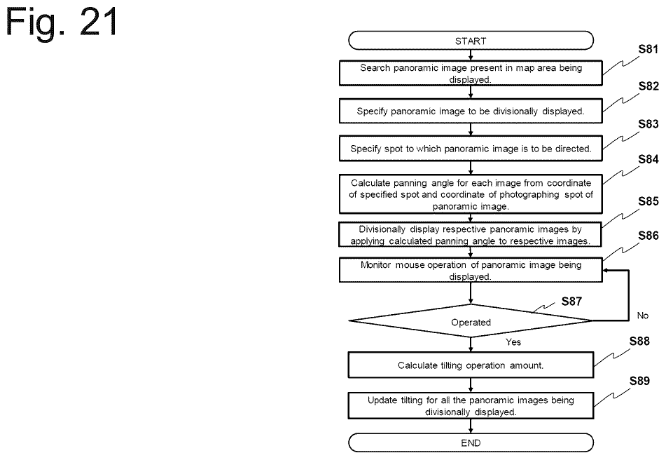

FIG. 21 illustrates a flow of another mode of controlling the sight direction of a plurality of panoramic images, when a those panoramic images are displayed in the divisional display format.

In this mode, the sight directions of the plurality of panoramic images are controlled so as to be directed toward one spot on the map.

As shown in FIG. 21, the panoramic image (panoramic photo image, for example) present in the map area displayed in the content display frame 39 is searched from the database 11 (S81). From those searched panoramic images, a plurality of panoramic images desired by the user to be displayed in the divisional display format are specified (S82). Moreover, the user specifies one spot to which those panoramic images are desired to be pointed on the displayed map or by an input of a geospatial coordinate value (S83). Then, on the basis of the geospatial coordinate of the specified spot and the geospatial coordinate of the viewpoint spot of each of the specified panoramic images (that is, the photographing spot of the panoramic photo), the panning angle for causing each of the panoramic images to be pointed to the specified spot is calculated (S84). Then, the plurality of specified panoramic images to which the calculated panning angles are applied, respectively, are displayed in the content display frame 39 in the divisional format (S85). In this way, the panning directions of the sights of all the displayed panoramic images are pointed to the same one specified spot.

And a mouse operation by the user for those plurality of panoramic images is monitored (S86), and when the mouse operation for any one of the panoramic images is detected (S87), the tilting operation amount of the mouse operation is calculated (S88). Then, the tilting of the calculated tilting operation amount is simultaneously applied to all the displayed panoramic images (S89), and the sights of all those panoramic images are changed only by the same tilting angle.

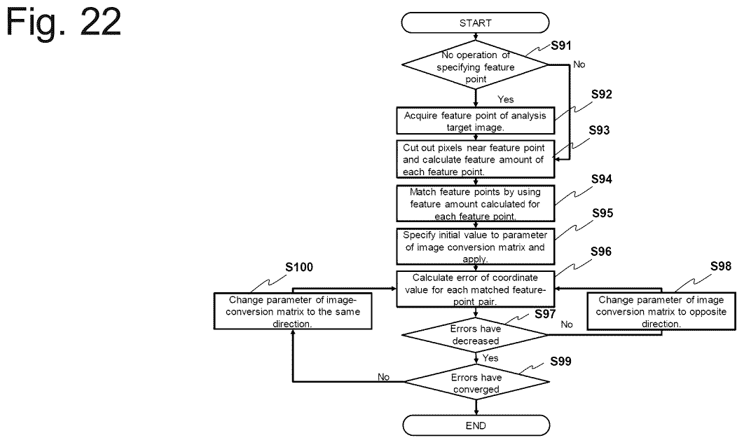

FIG. 22 illustrates a flow of control of positioning among the plurality of pieces of geospatial content (particularly, images) present in the same geospatial area. This control is executed as preprocessing so that calculation such as the calculation of an area and a volume shown in FIG. 19, for example, of comparing pieces of geospatial content present in the same geospatial area or of analyzing a difference between them, can be made with high accuracy by an analysis tool.

As shown in FIG. 22, in a plurality of images to be analyzed, whether the user has specified a feature point or not is checked (S91). If the user has specified a feature point (No at S91), the specified feature point is used as a clue for the positioning, and the control proceeds to Step S93. On the other hand, if the user has not specified a feature point (Yes at S91), a plurality of feature points are automatically identified in each of the plurality of images to be analyzed (S92), and the control proceeds to Step S93.

At Step S93, pixels of the area in the vicinity of an area including each feature point are extracted from each image, and a feature amount of each feature point is calculated from those extracted pixels. And matching processing for finding which of the feature points of an image matches feature points of the other images is executed by using the feature amount for each feature point among different images (S94).

And a predetermined initial value is set for a parameter of an image conversion matrix for performing zooming, parallel movement, rotation, skewing and the like of each image, respectively, and those image conversion matrixes are applied to each image (S96). After that, for each pair of feature points matched between images of each pair in the plurality of images to be analyzed, an error of a geospatial coordinate value is calculated (S97), and it is checked whether the errors have decreased from the errors calculated the previous time (S97). If the errors have not decreased, the parameter of the image conversion matrix is changed by a predetermined unit amount to a direction opposite to the parameter change direction from the parameter previous time to the parameter this time (S98), and the process proceeds to Step S96 again, and the error is calculated.

On the other hand, if the errors have decreased at Step S97, it is checked whether or not the errors of all the feature-point pairs of all the pair images to be analyzed have converged within a predetermined allowable error range (S99). As a result, if there is an error that has not converged yet, the parameter of the image conversion matrix related to the error is changed only by a predetermined unit amount in the same direction as the change direction from the previous time to this time (S100), and the control returns to Step S96 again.

As processes at Steps S96 to S100 are repeated, all the errors finally converge at Step S99, whereby this control is finished.

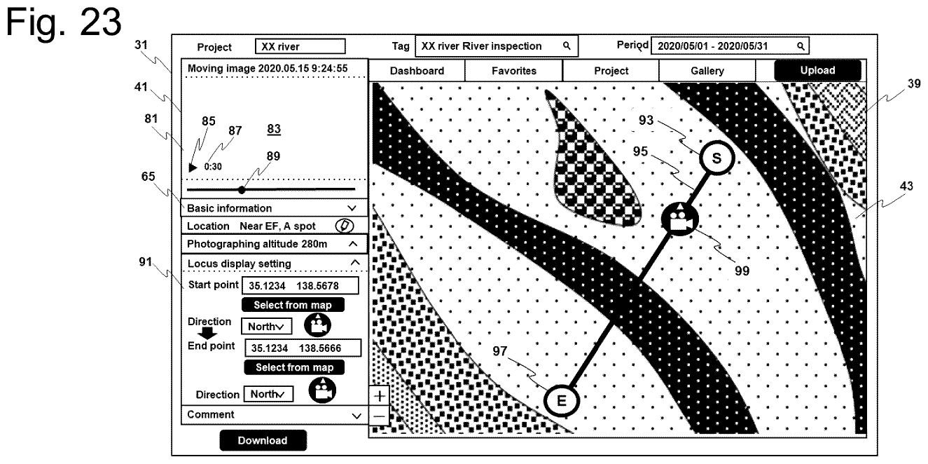

FIG. 23 illustrates an example of a screen displaying a panoramic image.

FIG. 23 illustrates an example in which the icon 51 of one panoramic image displayed in the content display frame 39 in the project screen 31 is selected by the user, and the selected panoramic image is displayed in the realistic image column 63 of the detailed display frame 41. The icon 51 of the panoramic image is arranged at the coordinate of the viewpoint (in a case of a panoramic photo, a photographing spot thereof) of the panoramic image on the map in the content display frame 39. The panoramic image displayed in the realistic image column 63 can be panned or tilted by the user through a mouse operation.

The content display unit 19 calculates an azimuth (that is, a panning angle) of a center position in a horizontal direction of a part displayed in the realistic image column 63 of the panoramic image on the basis of the geospatial coordinate of the panoramic image registered in the database 11 (an azimuth of the center position in the horizontal direction of the entire panoramic image, for example). When the user pans the aforementioned display part of the panoramic image, the content display unit 19 re-calculates the panning angle, that is, the azimuth of the center position of the aforementioned display part on the basis of the operation amount of the panning by the user and changes (pans) the aforementioned display part so as to match the azimuth. In addition, the content display unit 19 displays a sight mark 511 indicating the azimuth (sight direction) of the center position of the aforementioned display part of the panoramic image in association with the icon 51 of the panoramic image on the map in the content display frame 39. By means of this sight mark 511, the user can easily grasp in which direction of a panoramic image part he/she is viewing.

As described above, one embodiment has been explained, but this is exemplification for explanation of the present invention and is not intended to limit the present invention only to this embodiment. The present invention can be worked in other various forms within a range not departing from the gist thereof.

### REFERENCE SIGNS LIST

1 Geospatial information system
3 User terminal
11 Database
13 Content registration unit
15 Ortho generation unit
17 Tile-image generation unit
19 Content display unit
21 Content analysis unit
23 Analysis tool
25 Management table
25A Project management table
25B Content management table
27 Content file
31 Project screen
39 Content display frame
43 Map
45 Orthoimage
47, 49, 51, 53, 55 Content icon
57 Display content list
58 Thumbnail image of content
59 Divisional/overlap display switching button
61 Analysis tool icon
63 Upload button
63 Realistic image column
65 Basic information column
67 Comment editing column
69 Tag editing column
75 Analysis result data
83 Moving image
85 Playback button
87 Playback time point display
89 Playback time point mark
93 Start point mark
95 Locus mark
97 End point mark
99 Camera position mark
91 Locus setting column
101 Registration-method selection screen
106 Content selection screen
107 Content selection column
109 Map display column
111 Thumbnail image
113 Content icon
115 Content classification screen
117 File classification column
118 Classification modification screen
119 Movement-destination group box
121 Project registration screen
123 Project setting column

1. A geospatial information system which is connected communicably with a user terminal and provides geospatial information to the user terminal, the system comprising:
a database configured to manage one or more pieces of geospatial content:
a content registration unit configured to receive one or more pieces of geospatial content uploaded from the user terminal and register in the database the received pieces of geospatial content; and
a content display unit configured to provide one or more types of geospatial information screens, which are configured to display at least a part of the geospatial content registered in the database, to the user terminal, wherein
each of the geospatial content uploaded from the user terminal has any one of content types of a predetermined plurality of content types,
the content registration unit identifies the content type of each of the one or more pieces of geospatial content uploaded from the user terminal and registers in the database each of the uploaded geospatial content in a predetermined registration format according to the identified content type,
a geospatial coordinate associated with the geospatial content is included also in the predetermined registration format according to any one type of the one or more content types, and
the content display unit searches, by using a specified condition arbitrarily specified by the user with regard to predetermined one or more types of search conditions, the database for geospatial content matching the specified content, creates a first type of geospatial information screen having a first content display unit which displays in an overlapping manner a display image of the searched geospatial content at a position corresponding to the geospatial coordinate on a predetermined map, and provides the first type of geospatial information screen to the user terminal.

2. The geospatial information system according to claim 1, wherein
the types of the geospatial content include at least an orthoimage and one or more other types;
in a case where the searched geospatial content includes the orthoimage and one or more other types of geospatial content, when the content display unit creates the first type of geospatial information screen, the content display unit displays in the overlapping manner in the order of the map, a realistic image of the orthoimage, and icons of the other types of content from a rear surface toward a front surface in the first content display unit.

3. The geospatial information system according to claim 1, wherein
the types of the geospatial content include at least a moving image,
when the geospatial content uploaded from the user terminal include a moving image, the content registration unit specifies respective geospatial coordinates of a start point and an end point of the moving image, to register in the database the moving image in a registration format for moving image in which the moving image is associated with the respective geospatial coordinates of the start point and the end point;
when the first type of geospatial information screen is to be created, the content display unit arranges a realistic-image display unit which plays back and displays the moving image together with the first content display unit in the first type of geospatial information screen,
the content display unit further displays a camera position mark at a position on a movement locus from a geospatial coordinate of the start point up to a geospatial coordinate of the end point of the moving image on the map of the first content display unit, and
the content display unit further moves the camera position mark along the movement locus from the start point toward the end point in accordance with a playback time point when playing back the moving image in the realistic image display unit.

4. The geospatial information system according claim 1, wherein
the types of the geospatial content include at least analysis data which analyzes the geospatial content, and
when the first type of geospatial information screen is to be created, the content display unit displays in the overlapping manner in the order of the map, a realistic image of the orthoimage, the analysis data, and icons of the other pieces of content from the rear surface toward the front surface in the first content display unit.

5. The geospatial information system according to claim 1, wherein
the types of the geospatial content include at least a panoramic image,
when the geographic content uploaded from the user terminal include a panoramic image, the content registration unit registers the panoramic image in association with a geospatial coordinate of a viewpoint of the panoramic image and/or an azimuth of a predetermined spot of the panoramic image,
when the first type of the geospatial information screen is to be created, the content display unit arranges a panoramic image display unit which is configured to display the panoramic image together with the first content display unit in the first type of geographic information screen,
the content display unit further displays a mark at a position of a geographic coordinate of the viewpoint of the panoramic image on the map of the first content display unit, and
the content display unit further displays an azimuth of a center position of a part of the panoramic image displayed by the panoramic image display unit on the map of the first content display unit.

6. The geospatial information system according to claim 1, wherein
the types of the geospatial content include at least three-dimensional data,
when the geographic content uploaded from the user terminal include the three-dimensional data, the content registration unit registers in the database the three-dimensional data in association with a geospatial coordinate of a geospatial region in which the three-dimensional data exists, and
when the first type of geospatial screen is to be created, the content display unit arranges in the first type of geospatial information screen a three-dimensional data display unit configured to display the three-dimensional data together with the first content display unit.

7. The geospatial information system according to claim 1, wherein
the content display unit is capable of, in the first type of geospatial information screen, causing the user to select one or more pieces of geospatial content and causing the user to select an overlap display format and a divisional display format as a format for displaying the geospatial content, and
when the user selects one or more pieces of geospatial content and selects the divisional display format, in the first type of geospatial information screen, the content display unit creates a second type of geospatial information screen which has a second content display unit which displays in the divisional display format the selected geospatial content to be able to browse in contrast, and provides the second type of geospatial information screen to the user terminal.

8. The geospatial information system according to claim 7, wherein
the types of the geospatial content include at least a panoramic image, and
in a case where a plurality of the panoramic images are displayed in the divisional display format, when the user performs an operation of panning or tilting any one of the plurality of displayed panoramic images, the content display unit pans or tilts all the plurality of displayed panoramic images in accordance with an operation of the user.

9. The geospatial information system according to claim 7, wherein
in a case where a plurality of the panoramic images are displayed in the divisional display format, when the user specifies one spot on a map of the first type of geospatial information screen, the content display unit causes all the displayed plurality of panoramic images to be directed to the specified one spot.

10. The geospatial information system according to claim 1, wherein
when one or more pieces of geospatial content uploaded from the user terminal are received, the content registration unit specifies time and date of each of the received geospatial content and causes the user to set arbitrary one or more tags to each of the received geospatial content, and each of the received geospatial content is registered in the database in a predetermined registration format according to each content type associated with the identified time and date and the set tag, and
the predetermined one type or more search conditions include at least a period condition for narrowing the searched geospatial content by the time and date and a tag condition for narrowing the searched geospatial content by the tag.

11. The geospatial information system according to claim 1, wherein
the content registration unit is capable of registering one or more pieces of geospatial content uploaded from the user terminal in association with one or more projects arbitrarily set by the user,
the content registration unit is capable of causing the user to select a first registration method of registering one or more pieces of geospatial content in association with one project and a second registration method of registering a plurality of pieces of geospatial content in association with a plurality of projects,
when the second registration method is selected and a plurality of pieces of geospatial content are uploaded from the user terminal, the content registration unit automatically classifies the uploaded plurality of pieces of geospatial content into a plurality of groups, causes the user to execute desired modification for each of the classified plurality of groups, causes the user to set a project for each of the classified plurality of groups, and registers in the database the geospatial content belonging to each of the classified plurality of groups in association with the set project, and
the content display unit receives a request to open a project desired by the user from the user terminal and creates the first type of geospatial information screen by using a geospatial content in the database in association with the desired project and provides the same to the user terminal.

12. A geospatial information system according to claim 1, wherein
the first type of geospatial information screen has a tag editing unit that the user edits a tag of each geospatial content displayed on the first type of geospatial information screen.
